(19) United States
(12) Patent Application Publication
(10) Pub. No.: US 2008/0232297 A1
(43) Pub. Date: Sep. 25, 2008

(54) Node location method, node location system and server

(76) Inventors: Kenichi Mizugaki, Kodaira (JP); Ryosuke Fujiwara, Kodaira (JP)

Correspondence Address: REED SMITH LLP, Suite 1400, 3110 Fairview Park Drive, Falls Church, VA, 22042, US

(21) Appl. No.: 12/068,291

(22) Filed: Feb. 5, 2008

(30) Foreign Application Priority Data
Mar. 22, 2007 (JP) 2007-074724

(51) Int. Cl. H04B 7/185

(52) U.S. Cl. 370/316

(57) ABSTRACT

A node location system for detecting a node by receiving two or more access points. The node location system includes a node, a reference station, multiple access points, a server, and a network. After receiving a location signal, the reference station sends a reference signal, and the access points receive a position measurement signal and a reference signal, and detects a specified pattern from the received location signal and reference signal, and measures the time from detecting the specified pattern from the location signal until detecting the time from the reference signal, and sends the signal-receive-time information including that measured time to the server, and the server calculates the difference between the time the reference station received the location signal and the time that the access points received the location signal, and then calculates the node position based on this calculated differential.

### CLAIM OF PRIORITY

The present application claims priority from Japanese application JP 2007-074724 filed on Mar. 22, 2007, the content of which is hereby incorporated by reference into this application.

### FIELD OF THE INVENTION

This invention relates to a node location system including a node, reference station, access point, server and network.

### BACKGROUND OF THE INVENTION

A typical node location method is known in the related art for calculating the position by utilizing a signal from a satellite such as a GPS (global positioning satellite).

JP-A No. 2006-170891 and Kenichi Mizugaki and 9 others, “3 nW/bps Low Power UWB System (6): Study on Location System within 30-cm Error”, 2005 Electronics Society Symposium, IEICE, A-5-15, p. 139 disclose technology for calculating the node position based on the time found from subtracting the time that the access point received the measurement signal from the time that the reference station sent the reference signal.

JP-A No. 2005-140617 discloses technology for measuring the node position at an optional time.

JP-T No. 2006-526144 discloses technology for calculating the node position by using LORAN C.

JP-A No. 2006-186551 discloses technology for calculating the position of a newly added wireless device (or radio).

Atsushi Ogino and 5 others, “Integrated Wireless LAN Access System (1) Study on Location System”, 2003 Annual Symposium Archives, IEICE, B-5-203, p. 662 discloses technology for calculating the node position based on the difference between the time each access point received a signal sent from the node.

### SUMMARY OF THE INVENTION

The technology of the related art utilizing signals from a satellite required an antenna and a dedicated receiver and therefore has the problem of being unable to reduce the node size or lower the power consumption. This technology has the further problem that the device must be used outdoors in order to receive radio waves from the satellite.

The technology disclosed in patent document 1 has the problem that calculating the node position was impossible unless at least three access points (base stations) receive measurement signals and reference signals. The node positioning measurement system disclosed in patent document 1 therefore required many access points (base stations) and so a large cost.

In view of the aforementioned problems with the related art, this invention has the object of providing a node location system capable of calculating the node position when two or more access points received a position measurement signal and a reference signal.

A typical aspect of the node location system of this invention includes: a node for sending a location signal, a reference station for sending a reference signal, multiple access points for receiving a reference signal and a position measurement signal, a server for calculating the position of the node, and a network for connecting the access point with the server; and the node location method is characterized in that when the reference station sends a reference signal after receiving a position measurement signal; and the access point receives a position measurement signal and a reference signal, and detects a specific pattern from the received position measurement signal and the received reference signal, and measures the time from detecting the specified pattern from the position measurement signal until detecting the specified pattern from the reference signal, and sends the receive time information including the measured time to the server, and the server calculates the difference between the time the reference station received the position measurement signal and the time that the access points received the position measurement signal, and then calculates the node position based on this calculated differential.

In a typical aspect of this invention, the node position is calculated when two or more access points receive the position measurement signal and the reference signal.

### BRIEF DESCRIPTION OF THE DRAWINGS

FIG. 1 is a block diagram of the structure of the location system of the first embodiment of this invention;

FIG. 2 is a block diagram of the node structure in the location system of the first embodiment of this invention;

FIG. 3 is a block diagram showing the structure of the reference station in the location system of the first embodiment of this invention;

FIG. 4 is a block diagram of the structure of the location system of the first embodiment of this invention;

FIG. 5 is a block diagram showing the structure of the server in the first embodiment of the location system of this invention;

FIG. 6 is a drawing showing the structure of the access point position information table stored in the server 4 of the first embodiment of this invention;

FIG. 7 is a drawing showing the structure of the reference station position information table stored in the server of the first embodiment of this invention;

FIG. 8 is a drawing showing the structure of the reference signal sent from the reference station and the position measurement signal sent from the node in the first embodiment of this invention;

FIG. 9 is a flow chart of the node measuring process in the location system of the first embodiment of this invention;

FIG. 10 is a diagram for describing the time Tₘₑₐₙₛ in the first embodiment of this invention;

FIG. 11 is a diagram for describing the signal propagation delay time in the first embodiment of this invention;

FIG. 12 is a graph for describing the process delay time in the first embodiment of this invention;

FIG. 13 is a graph for describing the difference T_{abs} of the first embodiment of this invention;

FIG. 14 is a chart showing the process sequence of the positioning system of the first embodiment of this invention;

FIG. 15 is a block diagram of the structure of the location system of the third embodiment of this invention; and

FIG. 16 is a flow chart of the node location process of the location system of the third embodiment of this invention.

### DETAILED DESCRIPTION OF THE PREFERRED EMBODIMENTS

The embodiments of this invention are described next while referring to the drawings.

### First Embodiment

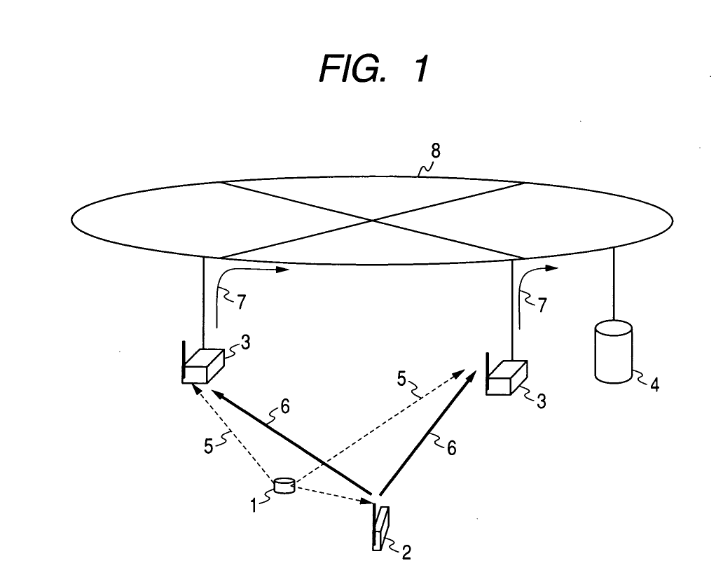

FIG. 1 is a block diagram of the structure of the location system of the first embodiment of this invention.

The node location system includes a node 1, a reference station 2, access points 3, and a server 4.

This block diagram shows only one node 1 and one reference station 2 but multiple nodes and reference stations may be utilized in the applicable position measurement system. Also, two access points 3 are shown in the drawing but the location system may include multiple access points. However, in this embodiment at least two base stations 3 must be installed in a range where the node 1 communication range and the reference station 2 communication range overlap.

Node 1 is the terminal device whose position is measured by this location system. The node 1 sends a location signal 5 when its position is being measured. This location signal 5 is a wireless packet used for measuring the position of the applicable node 1.

The reference station 2 sends a reference signal 6 after receiving the location signal 5 from the node 1. This reference signal 6 is a wireless packet for verifying the time that the reference station 2 send the reference signal 6.

The access point 3 receives the location signal 5 from the node 1. The access point 3 also receives the reference signal 6 from the reference station 2. The access pint 3 then measures the difference between the time the applicable location signal 5 was received and the time the applicable reference signal 6 was received.

The time that the access point 3 received the location signal 5 is the time that the applicable access point 3 detected the specified bit pattern contained in the applicable location signal 5. Similarly, the time that the access point 3 received the reference signal 6 is the time that the applicable access point 3 detected the specified bit pattern contained in the applicable reference signal 6.

The access point 3 sends a receive-time information 7 containing the difference between the time the applicable location signal 5 was received, and the time the applicable reference signal 6 was received, to the server 4 over the network 8. The network 8 may be wireless or wired.

The server 4 includes a system information database (not shown in drawing). The server 4 also connects over the network 8 to the access point 3. The server 4 calculates the position of the node 1 by utilizing information contained in the system information database and the receive-time information 7 that was received from each access point 3.

The UWB (Ultra Wideband) pulse method or the CDMA method is preferably used for communication in the location system of this embodiment.

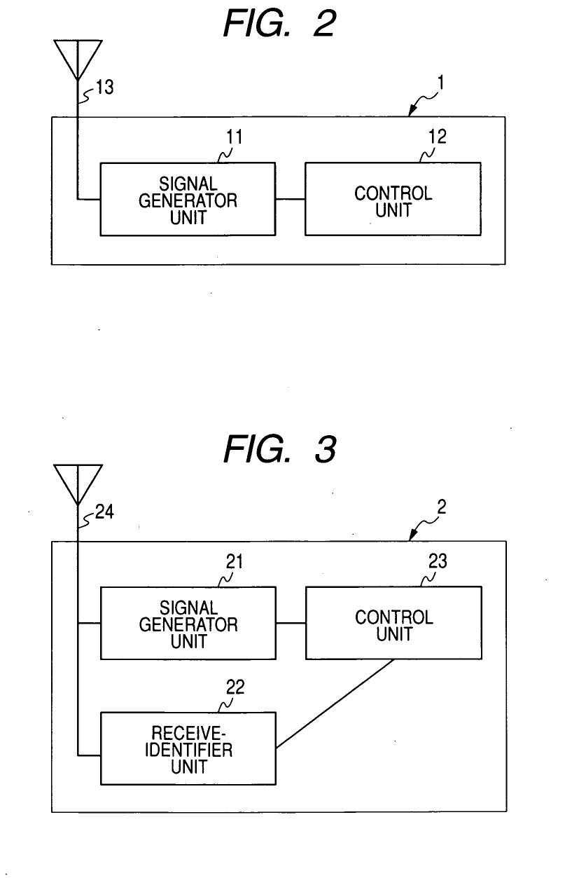

FIG. 2 is a block diagram showing the structure of the node 1 in the location system of the first embodiment of this invention.

The node 1 contains a signal generator unit 11, a control unit 12, and an antenna 13. The node 1 may include a sensor and timer. The node may be connected to a sensor and a timer, etc. Any type of sensor is acceptable if capable of measuring environmental information. The sensor may for example be able to abnormalities around the applicable node 1. The node 1 may be able to send the information measured by the sensor, by wireless to the access point 3.

A control unit 12 controls the overall processing of the applicable node 1. The control unit 12 sets the time that the node 1 sends the location signal 5, based on information from the sensor or timer connected to or contained in the applicable node 1 etc.

The control unit 12 also sets the time that the node 1 sends the location signal 5 when the access point 3 requests the transmission of the location signal 5.

The signal generator unit 11 generates the location signal 5 on receiving a command from the control unit 12 for sending the position measurement signal. The signal generator unit 11 sends the generated location signal 5 from the antenna 13 at the time set by the control unit 12.

The header in the location signal 5 contains a node ID which is an identifier for the node 1 that is the source of location signal 5. The reference station 2 and the access point 3 can therefore identify the node 1 source that received the location signal 5.

FIG. 3 is a block diagram showing the structure of the reference station 2 in the location system of the first embodiment of this invention.

The reference station 2 includes a signal generator unit 21, a receive-identifier unit 22, a control unit 23, and an antenna 24.

The receive-identifier unit 22 decides whether or not the signal received from the antenna 24 is the location signal 5 by decoding the signal received from the antenna 24. When the signal received from the antenna 24 is the location signal 5, then the receive-identifier unit 22 identifies the node 1 that is the source for the applicable location signal 5.

When a location signal 5 is received from the antenna 24, the control unit 23 sets the contents of the reference signal 6 formed by the signal generator unit 21 and the time that the applicable reference station 2 sends the reference signal 6, and instructs the signal generator 21. The control unit 23 may instruct the signal generator 21 to generate a signal, only when the source of the location signal 5 received from antenna 24 is the specified node 1.

The signal generator 21 generates a reference signal 6 after receiving a command from the control unit 23 to generate a reference signal. The signal generator 21 then sends the generated reference signal 6 from the antenna 24 at the time set by the control unit 23.

The reference signal 6 header contains a reference station ID as an identifier for the reference station 2 that is the source of the reference signal 6. The access point 3 can therefore identify the reference station 2 that is the source of the received reference signal 6.

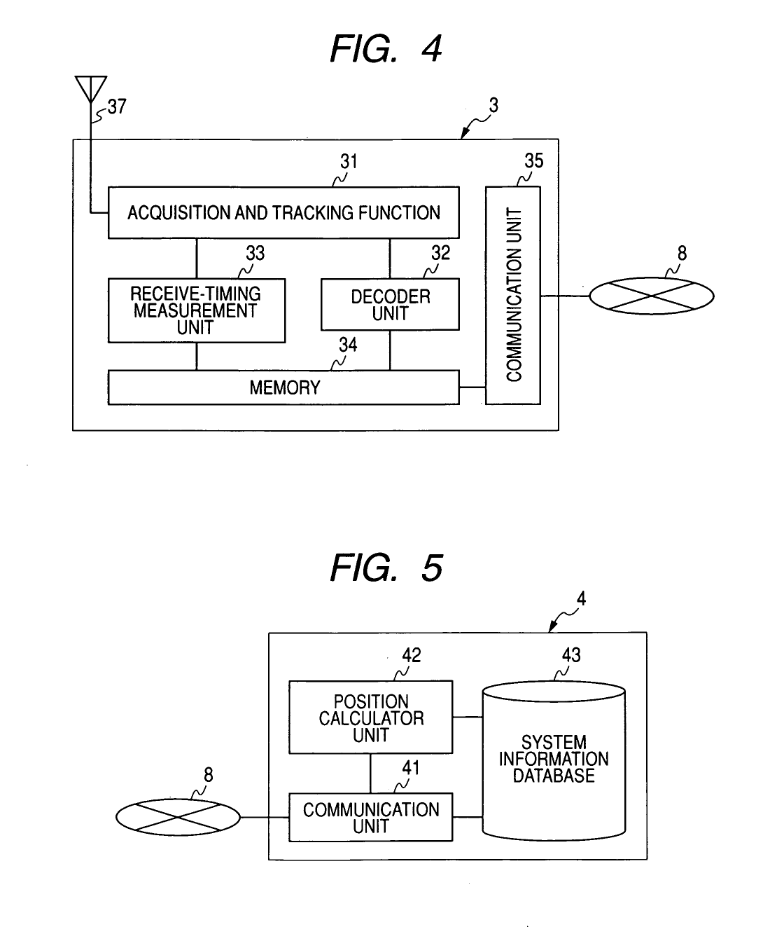

FIG. 4 is a block diagram of the structure of the access point 3 in the location system of the first embodiment of this invention.

The access point 3 includes an acquisition and tracking function 31, a decoder unit 32, a receive-time measurement unit 33, a memory 34, a communication unit 35, and an antenna 37.

The acquisition and tracking function 31 synchronizes the operating clock in the applicable access point 3 with the reference signal 6 sent from the reference station 2 and the location signal 5 sent from the node 1. The acquisition and tracking function 31 then loads (read out) a bit string from the reference signal 6 and the location signal 5.

The decoding unit 32 decodes the information from the bit string loaded by the acquisition and tracking function 31.

The receive-time measurement unit 33 measures the difference between the time that the applicable access point 3 received the location signal 5 and the time that the applicable access point 3 received the reference signal 6. The time that the access point 3 receives the location signal 5 is the time that the receive-time measurement unit 33 detected the specified bit pattern contained in the location signal 5. The time that the access point 3 received the reference signal 6 is likewise, the time that the receive-time measurement unit 33 detected the specified bit pattern contained in the reference signal 6.

The receive-time measurement unit 33 detects the number of clocks in access point 3 and the number of phase control signals for shifting the phase of the applicable operating clocks from the time that the specified bit pattern contained in the location signal 5 is detected, until the specified bit pattern contained in the reference signal 6 is detected. The receive-time measurement unit 33 in this way measures the difference between the time that the applicable access point 3 received the location signal 5 and the time that the applicable access point 3 received the reference signal 6.

The receive-time measurement unit 33 records the receive waveform of the location signal 5 and the reference signal 6 by using a high-speed sampler. Based on that recorded waveform, the receive-time measurement unit 33 may then measure the difference between the time that the applicable access point 3 received the location signal 5 and the time that the applicable access point 3 received the reference signal 6.

The receive-time measurement unit 33 then stores the receive-time information 7 including the measured difference, into the memory 34.

Instead of the difference between the time the applicable access point 3 received the location signal 5 and the time the applicable access point 3 received the reference signal 6, the receive-time information 7 may include the time the applicable access point 3 received the location signal 5 and the time the applicable access point 3 received the reference signal 6. In that case, the server 4 calculates the difference between the time that the applicable access point 3 received the location signal 5 and the time that the applicable access point 3 received the reference signal 6, based on the receive-time information 7.

The memory 34 stores the receive-time information 7.

The communication unit 35 sends the receive-time information 7 that was stored in the memory 34, by way of the network 8 to the server 4.

The access points 3 of this embodiment as described above may be a simple structure including a receive-time measurement unit 33 built into a typical radio communication device.

An example of an access point 3 using the impulse method where communication utilizes impulse signals is described next.

The acquisition and tracking function 31 contains a matched filter, a time control device, a demodulator unit and a pattern detector unit.

The time control unit adjusts the phase of the input location signal 5 or the reference signal 6 pulse string so that the output from the matched filter is at a maximum.

The demodulator unit converts the matched filter output to a bit string. The pattern detector unit detects a specific bit pattern from the bit string converted by the demodulator unit. When a specified bit pattern is detected, the pattern detector unit sends the pattern detection signal to the receive-time measurement unit 33.

If this specified bit pattern is an SFD (Start of Frame Delimiter) then the pattern detector unit sends the bit string from the SFD onwards to the demodulator unit 32. The demodulator unit 32 reads the contents of the location signal 5 or the reference signal 6 by demodulating the bit string received from the pattern detector unit.

FIG. 5 is a block diagram showing the structure of the server 4 in the first embodiment of the location system of this invention.

The server 4 contains a communication unit 41, a position calculator unit 42, and a system information database 43. The communication unit 41, position calculator unit 42, and a system information database 43 are configured by a processor, a memory, and an interface.

The communication unit 41 is an interface connecting to the network 8. The communication unit 41 receives the receive-time information 7 from the access point 3. The communication unit 41 then transfers that receive-time information 7 to the position calculator unit 42.

The system information database 43 stores information relating to the applicable location system. More specifically, the system information database 43 stores the access point position information table 431 and the reference station position information table 432. Moreover, the system information database 43 may also store the distance between the reference station 2 and each access point 3, and may record the propagation time of the reference signal 6 from the reference station 2 to each access point 3.

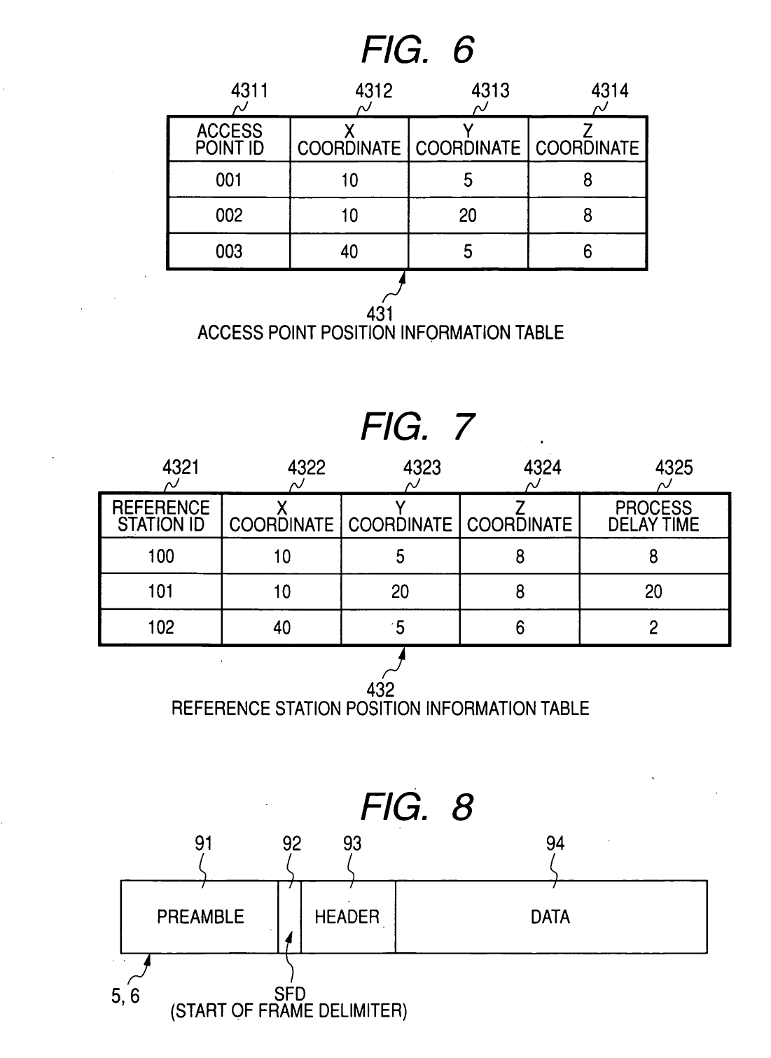

The access point position information table 431 is for managing the access point 3 positions. The access point position information table 431 is described in detail using FIG. 6.

The reference station position information table 432 manages the reference station 42 positions. The reference station position information table 432 is described in detail using FIG. 7.

The position calculator unit 42 calculates the node 1 position based on the information stored in the system information database 43 and the receive-time information 7 that was received from the communication unit 41.

FIG. 6 is a drawing showing the structure of the access point position information table 431 stored in the server 4 of the first embodiment of this invention.

The access point position information table 431 contains an access point ID 4311, an X coordinate 4312, a Y coordinate 4313, and a Z coordinate 4314.

The access point ID4311 is an identifier of the access points 3.

The X coordinate 4312 indicates the position of the access point 3 identified by the access point ID 4311 in the applicable record along the X axis. The Y coordinate 4313 indicates the position of the access point 3 identified by the access point ID4311 in the applicable record along the Y axis. The Z coordinate 4314 indicates the position of the access point 3 identified by the access point ID4311 along the Z axis.

The X axis, Y axis and Z axis may be defined as needed within the location system if the axes meet each other at right angles

FIG. 7 is a drawing showing the structure of the reference station position information table 432 stored in the server 4 of the first embodiment of this invention.

The reference station position information table 432 contains a reference station ID4321, an X coordinate 4322, a Y coordinate 4323, a Z coordinate 4324 and a process delay time 4325.

The reference station ID4321 is an identifier for the reference station 2. The X coordinate 4322 indicates the position of reference station 2 identified by the reference station ID4321 along the X axis in the applicable record. The Y coordinate 4323 indicates the position of the reference station 2 identified by the reference station ID 4321 in the applicable record along the Y axis. The Z coordinate 4324 indicates the position of the reference station 2 identified by the reference station ID 4321 in the applicable record along the Z axis.

The process delay time 4325 is the time required for the reference station 2 identified by reference station ID4321 in the applicable record to send the reference signal 6 after receiving the location signal 5.

FIG. 8 is a drawing showing the structure of the reference signal 6 sent from the reference station 2 and the location signal 5 sent from the node 1 in the first embodiment of this invention.

The location signal 5 and the reference signal 6 is a wireless packet and includes the preamble 91, the SFD (Start of Frame Delimiter) 92, the header 93 and the data unit 94.

The preamble 91 is utilized to synchronize the time of the reference station 2 or the access point 3 that received the location signal 5 and the reference signal 6. The SFD92 indicates the end of the preamble 91. In this embodiment, the SFD92 is utilized as a designated bit pattern for determining the receive time.

The header 93 contains information such as the transmit destination identifier and the source identifier of the location signal 5 and the reference signal 6. Instead of the SFD92, a portion of the information contained in the header 93 may be utilized as a specified bit pattern for setting the receive time.

The position of just the applicable node l for example is measured by using the specific bit pattern of the node 1 identifier that must be measured.

The applicable location signal 5 and the reference signal 6 are stored in the data unit 94. A section of the information contained in the data unit 94 may be used as the specified bit pattern for setting the receive time instead of the SFD92.

The location signal 5 and the reference signal 6 contain for example a “168 bit” preamble 91, an “8 bit” SFD92, a “48 bit” header 93, and a “200 bit” data unit 94.

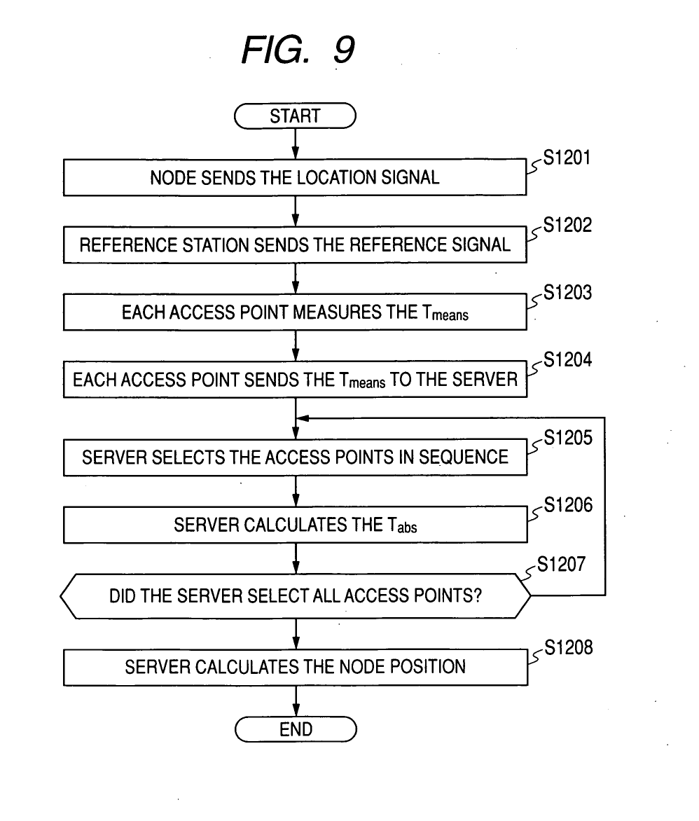

FIG. 9 is a flow chart of the node location process in the location system of the first embodiment of this invention.

The node 1 first of all sends a location signal 5 (S1201) Each access point 3 then utilizes the preamble 91 in the location signal 5 sent from the node 1 to synchronize with the receive time, and receive the applicable location signal 5.

The reference station 2 on the other hand, usually monitors the location signal 5 sent from the node 1. The reference station 2 in other words, is in a standby state capable of receiving the location signal 5. When the reference station 2 receives the location signal 5 sent from the node 1, the reference station 2 sends a reference signal 6 to the access point 3 (S1202).

The reference station 2 sends the reference signal 6 to the access point 3 after the process delay time has elapsed after receiving the location signal 5. Sending after the delay time has elapsed prevents the reference signal 6 sent from the reference station 2 from overlapping onto the wave reflected from the location signal 5 send from the node 1.

The access point 3 next synchronizes with the receive time by utilizing preamble 91 of reference signal 6 send from the reference station 2, and receives the applicable reference signal 6.

Each access point 3 measures the time Tₘₑₐₙₛ from receiving the location signal 5 to receiving the reference signal 6 at this time (S1203). This time Tₘₑₐₙₛ is described in detail in FIG. 10.

Next, each access point 3 sends the receive-time information 7 to the server 4 (S1204). The receive-time information 7 includes the measured time Tₘₑₐₙₛ, the identifier for the applicable access point 3, the identifier for the source node 1 of location signal 5 received by the applicable access point 3, and the identifier for the source reference station 2 of reference signal 6 received by the applicable access point 3, etc.

The server 4 receives the receive-time information 7 from each access point 3. The server 4 can calculate the node 1 position if the receive-time information 7 can be received from two access points 3.

The server 4 next selects in sequence, all the access point 3 (sending the receive-time information 7) sources (S1205).

If receive-time information 7 was in fact received from two access points 3, then the server 4 selects in order, two applicable access points 3. If receive-time information 7 was received from three or more access points 3, then the server 4 may selects an optional two access points in order from among those three or more access points 3.

The server 4 next extracts the Tₘₑₐₙₛ, the access point 3 identifier, and the reference station 2 identifier from the receive-time information 7 sent from the access point 3.

The server 4 next selects a record where the extracted access point 3 identifier matches the access point ID4311 from record access point position information table 431. The server 4 next extracts the X coordinate 4312, the Y coordinate 4313, and the Z coordinate 4314 from the selected record.

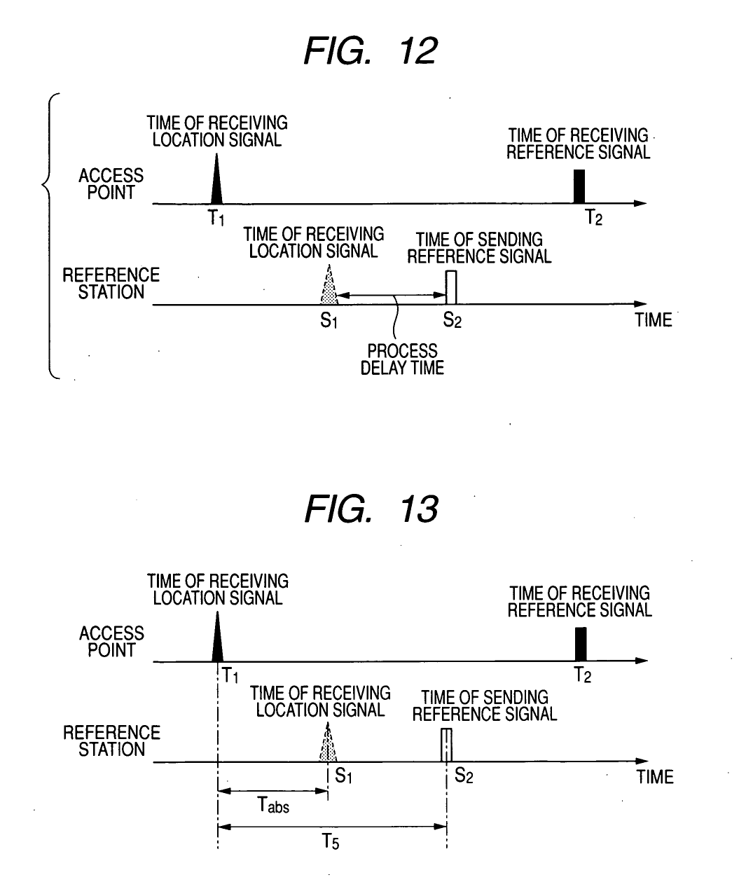

The server 4 next selects a record where the extracted reference station 2 identifier matches the matches the reference station ID4321 from the reference station position information table 432. The server 4 next extracts an X coordinate 4322, a Y coordinate 4323, and a Z coordinate 4324, and a process delay time 4325 from the selected record. The process delay time 4325 is described in detail in FIG. 12.

The server 4 next calculates the distance between the selected access point 3 and the reference station 2, based on the extracted X coordinate 4312, the Y coordinate 4313, and the Z coordinate 4314, X coordinate 4322, a Y coordinate 4323, and a Z coordinate 4324.

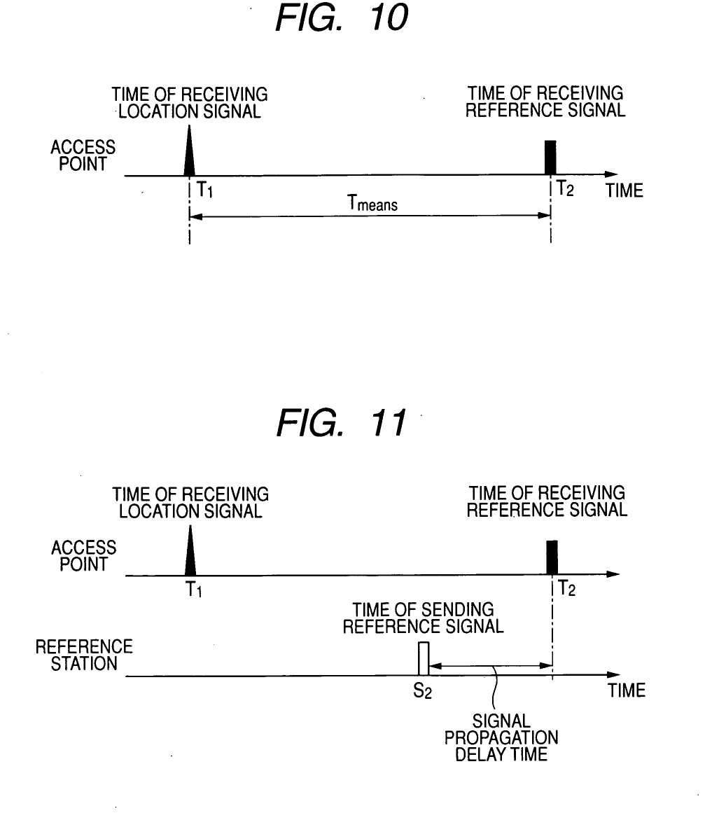

The server 4 next calculates the signal propagation delay time between the selected access point 3 and the reference station 2, by dividing the calculated distance by the speed of light. This signal propagation delay time is described in detail in FIG. 11.

The server 4 next subtracts the calculated signal propagation delay time from the extracted Tₘₑₐₙₛ. The server 4 in this way calculates the difference T₅ between the time that the selected access point 3 received the location signal 5, and the time that the reference station 2 sent the reference signal 6.

The server 4 next subtracts the extracted process delay time 4325 from the calculated difference T₅. The server 4 in this way calculates the difference T_{abs} between the time that the selected access point 3 received the location signal 5, and the time that the reference station 2 received the location signal 5 (S1206). This difference T_{abs} is described in detail in FIG. 13.

The server 4 next decides whether or not all source access points 3 for the receive-time information 7 were selected in step S1205 (S1207).

If neither of the source access points 3 for the receive-time information 7 are selected, then the server 4 returns to step S1205. The server 4 then selects the next access point 3 and calculates the difference T_{abs} between the time the selected access point 3 received the location signal 5, and the time that the reference station 2 received the location signal 5.

On the other hand, if all the source access points 3 for the receive-time information 7 were selected then the server 4 calculates the position of the node 1 based on the calculated difference T_{abs}, the position of each access point 3, and the position of the reference station 2 (S1208). The node location process then ends.

The access point 3 position is the X coordinate 4312, the Y coordinate 4313, and the Z coordinate 4314 extracted in step S1206. The reference station 2 position is the X coordinate 4322, a Y coordinate 4323, and a Z coordinate 4324 extracted in step S1206.

The server 4 may for example calculate the node 1 position by using the maximum likelihood method or the hyperbolic location method.

In the maximum likelihood method, the server 4 estimates the node 1 position. If temporarily decided the node 1 is present at the estimated position, the server 4 calculates the difference T_{abs}, between the time the access point 3 received the location signal 5 and the time the reference station 2 received the location signal 5, for each of the access points 3. The server 4 calculates the mean squared error of the difference T_{abs}, in the case that the node 1 position was estimated with the difference T_{abs}, calculated in step S1206, for each of the access points 3. The server 4 next determines the node 1 position as the position where the total sum of the mean squared errors is smallest.

In the hyperbolic location method on the other hand, the server 4 draws a hyperbola between the reference station 2 and each access point 3, at the coordinate cluster satisfying the difference T_{abs} calculated in step S1206. The server 4 then determines the intersection of drawn hyperbolae as the node 1 position.

The description of the present embodiment assumes as a precondition that the access points 3 receive the location signal 5 and the reference signal 6 as direct radio waves. However, the access points 3 may receive at least one of either the location signal 5 or the reference signal 6 as indirect waves rather than direct waves. In that case, the server 4 corrects the time Tₘₑₐₙₛ included in the receive-time information 7 received from the access point 3. For example if the location signal 5 and reference signal 6 were received as direct radio waves, then the server 4 employs signal processing to correct the time Tₘₑₐₙₛ included in the receive-time information 7. The server 4 in this way enhances the measurement accuracy of the node 1 position.

FIG. 10 is a diagram for describing the time Tₘₑₐₙₛ in the first embodiment of this invention.

The time Tₘₑₐₙₛ is the difference between the time T₁ that the access point 3 received the location signal 5, and the time T₂ that the applicable access point 3 received the reference signal 6.

The receive-time measurement unit 33 contained in access point 3 measures the time Tₘₑₐₙₛ. The receive-time measurement unit 33 then sends this measured time Tₘₑₐₙₛ to the server 4.

FIG. 11 is a diagram for describing the signal propagation delay time in the first embodiment of this invention.

The signal propagation delay time between the access point 3 and the reference station 2 is the difference between the time S₂ that the reference station 2 sent the reference signal 6 and the time T₂ that the access point 3 received the applicable reference signal 6.

The server 4 extracts the access point 3 coordinates from the access point position information table 431. The server 4 next extracts the reference station 2 coordinates from the reference station position information table 432. Next, the server 4 calculates the distance between the access point 3 and the reference station 2 based on the extracted access point 3 coordinates and the extracted reference station 2 coordinates. The server 4 next calculates the signal propagation delay time between the access point 3 and the reference station 2, by dividing the calculated distance by the speed of light.

FIG. 12 is a diagram for describing the process delay time in the first embodiment of this invention.

The reference station 2 process delay time is the difference between the time S₁ that the reference station 2 received the location signal 5 and the time S₂ that the reference station 2 sent the reference signal 6.

The process delay time for reference station 2 is managed by the reference station position information table 432 contained in the server 4. The server 4 then extracts the process delay time for reference station 2 from the reference station position information table 432.

FIG. 13 is a diagram for describing the difference T_{abs} of the first embodiment of this invention.

The difference T_{abs} is the difference between the time T1 that the access point 3 received the location signal 5 and the time S1 that the reference station 2 received the location signal 5.

The server 4 subtracts the calculated signal propagation delay time from the time Tₘₑₐₙₛ received from the access point 3. The server 4 in this way calculates the difference T₅ between the time that the access point 3 received the location signal 5 and the time that the reference station 2 send the reference signal 6.

Next, the server 4 subtracts the process delay time extracted from reference station position information table 432 from the calculated difference T₅. The server 4 in this way, calculates the difference T_{abs} between the time T₁ that the access point 3 received the location signal 5, and the time S₁ that the reference point 2 received the location signal 5.

The server 4 then calculates the node 1 position based on the calculated difference T_{abs}.

In the technology disclosed in patent document 1, the server 4 calculated the node 1 position based on difference T₅. The server 4 was therefore required to calculate for three or more access points, the difference T₅. for the time that the access point 3 received the location signal 5 and the time that the reference station 2 sent the reference signal 6. Based on these three calculated difference T₅, the server 4 then calculates the difference between the time that two of the access points 3 received the location signal 5, and then calculated the node 1 position. The technology disclosed in patent document 1 in other words required the installation of at least three access points 3 in a range overlapping the reference station 2 communication range and the node 1 communication range. Three access points 2 are needed because the server 4 did not use the time S₁ in which reference station 2 received the location signal 5, for calculating the node position 1 in the technology disclosed in patent document 1.

In this embodiment on the other hand, the server 4 calculates the node 1 position based on the difference T_{abs} between the time T₁ that the access point 3 received the location signal 5, and the time S₁ that the reference station 2 received the location signal 5. In other words, the server 4 utilizes the time S₁ that the reference station 2 received the location signal 5, for calculating the node 1 position. The server 4 therefore only has to calculate the difference T_{abs} between the time T₁ that the access point 3 received the location signal 5 and the time S1 that the reference station 2 received the location signal 5 for two access points 3. This embodiment in other words only requires that at least two access points be installed in a range overlapping the reference station 2 communication range and the node 1 communication range. The positioning system of this embodiment can be achieved at a lower cost than the location system disclosed in patent document 1.

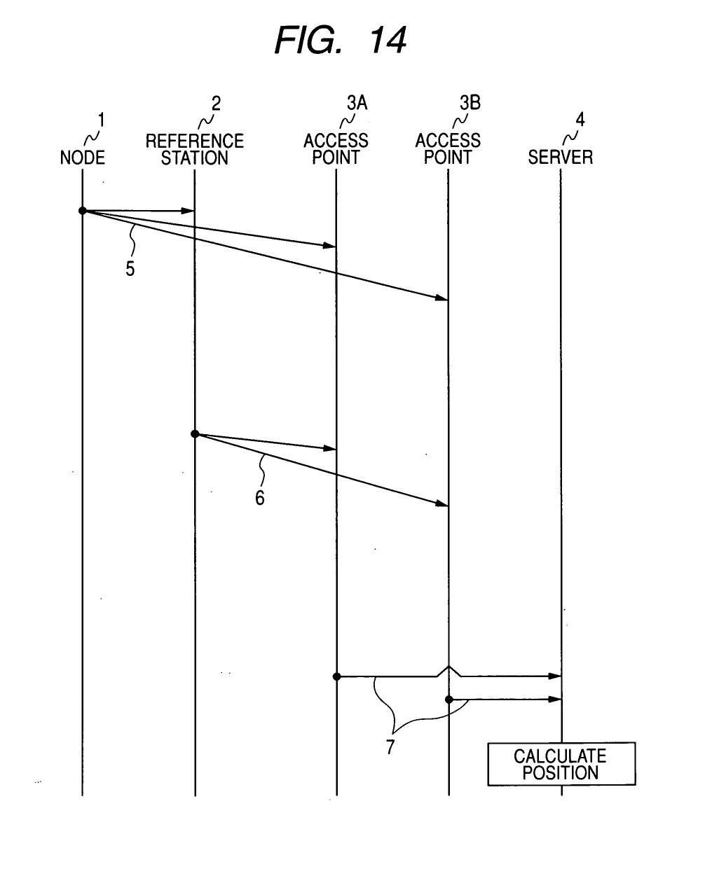

FIG. 14 is a diagram showing the process sequence of the location system of the first embodiment of this invention.

In this sequence diagram, an access point 3A and 3B are installed in a range overlapping the node 1 communication range and the reference station 2 communication range.

The node 1 sends the location signal 5 to the access points 3A, 3B and the reference station 2 at the optional time desired for location. The node 1 for example sends the location signal 5 periodically or when a sensor for node 1 detected an abnormality.

The reference station 2 receives the location signal 5 from the node 1. After the process delay time has elapsed after receiving the location signal 5, the reference station 2 sends the reference signal 6 to the access point 3A and 3B.

The access points 3A and 3B on the other hand, receive the location signal 5 and the reference signal 6. The access points 3A and 3B at this time measure the Tₘₑₐₙₛ until the reference signal 6 is received after receiving the location signal 5. The access points 3A and 3B then send the receive-time information 7 containing the measured time Tₘₑₐₙₛ to the server 4.

The server 4 receives the receive-time information 7 from the access points 3A and 3B. The server 4 next calculates the node 1 position based on that receive-time information 7 and the information stored in the system information database 43.

The present embodiment therefore allows the server 4 to calculate the node 1 position even if the node 1 does not contain a receive function. The structure of the node 1 can therefore be simplified, and the node 1 made smaller.

The server 4 can calculate the node 1 position from (just) one transmission of the location signal 5 from the node 1. The node 1 energy consumption can therefore be lowered.

The server 4 can calculate the node 1 position just by way of the usual data sent by the node 1 since the location signal 5 is a wireless packet. In other words, the server 4 can calculate the node 1 position even without sending a signal just for requesting measurement of the node 1 position.

Moreover, there is no need to synchronize each access point 3 time prior to measuring the node 1 position. The server 4 can therefore calculate the node 1 position at the desired time (for example, the instant where node 1 detected an abnormality).

Also, other than a typical wireless receiver, there is also no need for the access point 3 to include a receiver used for receiving location signals (including the location signal 5 and reference signal 6). The access point 3 may in other words, include a receive-time measurement unit 33 in the usual wireless communication device. The structure of the access point 3 can therefore be simple, and the access point 3 made smaller. The cost of the access point 3 can also be lowered.

Also in the present embodiment, only two access points 3 need be installed in the range where the node 1 communication range and the reference station 2 communication overlap. The number of access points 3 can therefore be reduced so the location system cost can be lowered.

### Second Embodiment

In the first embodiment, the process delay time for reference station 2 was fixed. However, the process delay time for the reference station 2 might not be a fixed value depending on the circuit configuration of reference station 2. Here, the case is described where the process delay time for reference station 2 is not a fixed value in the second embodiment.

The structure of the location system of the second embodiment is identical to the location system of the first embodiment so a description is omitted here.

The node positioning measuring process for the location system of the second embodiment includes the node location process (FIG. 9) of the location system of the first embodiment. In the second embodiment, the server 4 increases or decreases the process delay time (of the reference station 2) by one clock pulse in the internal clock in the applicable reference station 2. The server 4 then calculates the node 1 position by using this increased process delay time. The server 4 also calculates the node 1 position by using the decreased process delay time.

The server 1 then sets the node 1 position as the most appropriate position from among the calculated three positions.

The server 4 may for example calculate the likelihood for the calculated node 1 position. The server 4 calculates the likelihood(s) by using the follow formula 1.

$$likelihood ( s ) = {\sum }_{X = 3 A , 3 B} {[ \begin{matrix}( \begin{matrix}Distance between s and access point X - \\ distance between s and referencestation\end{matrix} ) - \\ {T}_{abs} of access point X \times {C}_{0}\end{matrix} ]}^{2} \qquad Formula 1$$

In the above formula, s is the position calculated for node 1. The T_{abs} of access point X is the difference between the time the access point X received the location signal 5 and the time the reference station 2 received the location signal 5. Also, C₀ is the speed of light. The access points 3A and 3B are installed in a range overlapping the communication range of node 1 and the communication range of reference station 2.

The server 4 then sets the node 1 position to the position calculated as the minimum likelihood from among the three calculated positions.

This embodiment is capable of calculating the position of node 1 with high accuracy even if the process delay time for the reference station 2 is not fixed.

### Third Embodiment

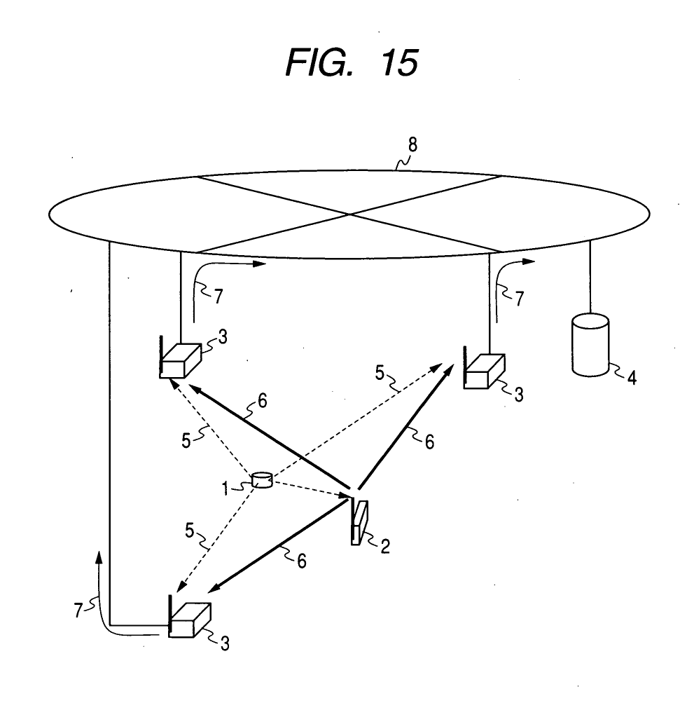

FIG. 15 is a block diagram of the structure of the location system of the third embodiment of this invention.

This measuring system contains a node 1, a reference station 2, an access point 3 and a server 4.

Only one each of the node 1 and the reference station 2 are shown in this block diagram but the applicable location system may contain multiple nodes 1 and reference stations 2. Also, three access points 3 are shown in this drawing but the applicable location system may contain several access points. However this embodiment requires that at least three of the access points 3 be installed in a range overlapping the node 1 communication range and the reference station 2 communication range.

The node 1, the reference station 2, the access point 3 and the server 4 are all the same as in the location system of the first embodiment (FIG. 1) so a description is omitted here.

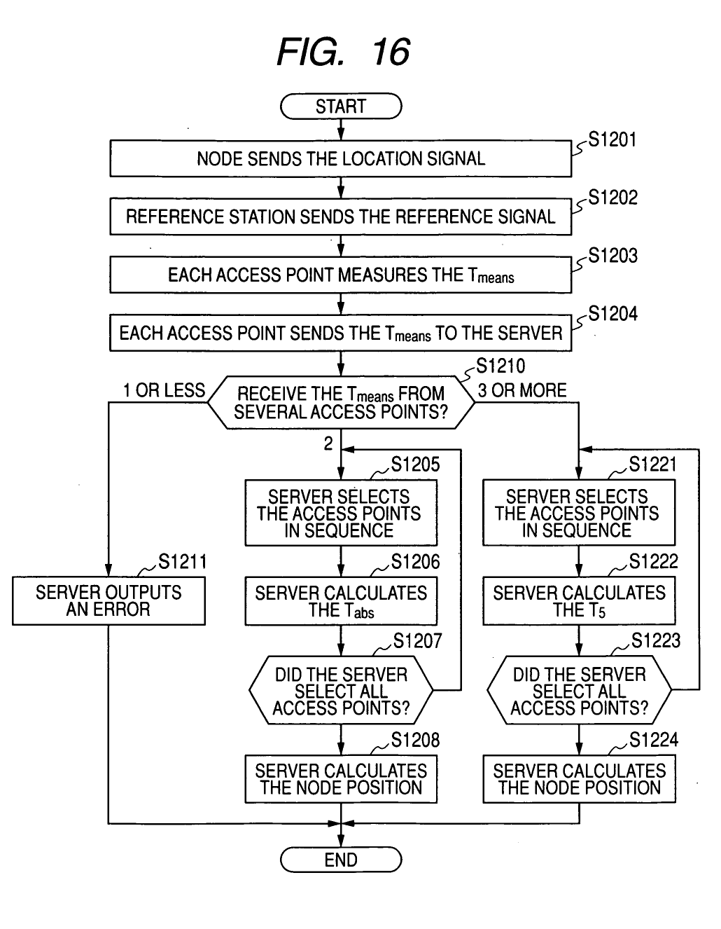

FIG. 16 is a flow chart of the node location process of the location system of the third embodiment of this invention.

The steps S1201 through S1204 are first executed. The steps S1201 through S1204 are identical to the steps contained in the node location process (FIG. 9) of the first embodiment so a description is omitted here.

Next, the server 4 specifies the number of access points 3 that sent the receive-time information 7 including the time Tₘₑₐₙₛ (S1210).

The server 4 cannot calculate the node 1 position if the receive-time information 7 was received from one access point 3 or none of the access points 3. If that case occurs then the server 4 outputs an error (S1221). The node location process then ends.

However if the receive-time information 7 was received from two access points 3, then the server 4 executes the steps 1205 through S1208. These steps 1205 through S1208 are identical to those steps contained in the node location process (FIG. 9) of the first embodiment so a description is omitted here. The node location process then ends.

On the other hand, if the receive-time information 7 was received from three or more access points 3 then the server 4 selects all of the source access points 3 for receive-time information 7 in sequence (S1221).

The server 4 for example selects three of the applicable access points 3 in sequence when the receive-time information 7 was received from three access points 3. If the receive-time information 7 was received from four or more access points 3 then the server 4 may select a desired three among those four or more access points 3 in sequence.

The server 4 next extracts the time Tₘₑₐₙₛ, the access point 3 identifier and the reference station 2 identifier from the receive-time information 7 sent from the selected access points 3.

The server 4 next selects a record from access point position information table 431, where the access point ID4311 of access point position information table 431 matches the extracted access point 3 identifier. Next, the server 4 extracts the X coordinate 4312, Y coordinate 4313, and the Z coordinate 4314 from the selected record.

The server 4 next selects a record from the reference station position information table 432, where the reference station ID4321 of reference station position information table 432 matches the identifier for the extracted reference station 2. Next, the server 4 extracts the X coordinate 4322, Y coordinate 4323, and the Z coordinate 4324 from the selected record.

The server 4 then calculates the distance between the selected access point 3 and the reference station 2 based on the extracted X coordinate 4312, Y coordinate 4313, and the Z coordinate 4314, and the X coordinate 4322, Y coordinate 4323, and the Z coordinate 4324.

Next the server 4 calculates the signal propagation delay time between the selected access point 3 and the reference station 2 by dividing the calculated distance by the speed of light.

The server 4 then subtracts the calculated signal propagation delay time from the extract time Tₘₑₐₙₛ. The server 4 then calculates the difference T5 between the time that the selected access point 3 received the location signal 5 and the time that the reference station 2 sent the reference signal 6 (S1222).

Then in step S1221, the server 4 then decides whether or not all access points 3 that are receive-time information 7 sources (S1223) were selected.

If none of the access points 3 that were sources for receive-time information 7 were selected then the server 4 returns to step S1221. The server 4 then selects the next access point 3 and calculates the difference T₅ between the time the selected access point 3 received the location signal 5 and the time that the reference station 2 sent the reference signal 6.

On the other hand, when all access points 3 that were sources for receive-time information 7 were selected then the server 4 calculates the node 1 position based on the calculated difference T₅ and the position of each access point 3 (S1224) The server 4 for example calculates the node 1 positions using the maximum likelihood method or the hyperbolic location method. The access point 3 position is the X coordinate 4312, the Y coordinate 4313, and the Z coordinate 4314 extracted in step S1222.

The node location process then ends.

If the receive-time information 7 was received from three or more access points 3, then the server 4 executes the steps S1205 through S1208 in addition to the steps S1221 through S1224.

In that case the server 4 uses the formula 1 to calculate the likelihood(s) for the node 1 calculated in step S1208. The server 4 also uses the formula 2 to calculate the likelihood(s) for node 1 in step S1224.

$$likelihood ( s ) = {\sum }_{X = 3 B , 3 C} {[ \begin{matrix}( \begin{matrix}Distance between s and access point X - \\ distance between s and access point 3 A\end{matrix} ) - \\ {T}_{3 AX} \times {C}_{0}\end{matrix} ]}^{2} \qquad Formula 2$$

Here, s is the calculated node 1 position. Also, T_{3AX} is the difference between the time the access point 3A received the location signal 5 and the time that the access point X received the location signal 5. The C₀ is the speed of light. The access points 3A, 3B and 3C are installed in a range overlapping the communication range of node 1 and the communication range of the reference station 2.

The server 4 then sets the node 1 position to the position calculated as the small likelihood position from among the positions calculated in step S1208 and the positions calculated in step S1224.

This embodiment allows the server 4 to continue measuring the node 1 positions even if a problem has occurred in any of the access points 3 in the node location system.

The present invention can be utilized for calculating node positions in wireless LAN systems, and utilized in particular in node location systems with a simple structure where power consumption has been reduced.

This invention can for example be utilized in hydrogen leak alarm systems at hydrogen stations that supply hydrogen gas used in fuel cells for automobiles. The nodes containing hydrogen sensors (sensor nodes) in these hydrogen leak alarm systems can be installed at optional locations, or can be carried by the worker to detect hydrogen leaks. These sensor nodes promptly send a location signal when hydrogen gas is detected. Each access point on the sensor node periphery then receives the location signal. The reference station on the other hand sends a reference signal after receiving the location signal from the sensor node. The access points on the sensor node periphery then receive that reference signal. The time from receiving the location signal until receiving the reference signal is then measured at this time, at each access point on the node periphery.

Each access point then sends the receive-time information including the measured time, to the server connected on the cable or wire network. The server then calculates the position where the sensor node detected an abnormality, based on the receive-time information, and the coordinates of each access point and coordinates of the reference station, etc.

Unless the access point and the reference station positions were changed there is no need for the hydrogen leak alarm system to rewrite the information stored in the server, even if the sensor node positions were changed. Moreover the sensor nodes can be made in a small size since the node positions can be measured without the nodes possessing a receiver function. This small size allows using different carrying methods such as embedding the nodes inside the name tags of the worker. There is also no need for synchronizing each access point in advance with the sensor node location so the hydrogen sensor can make measure the node position at the instant that the hydrogen sensor detected an abnormality. Also, there is no need to trace the worker's position until the sensor detects an abnormality so that the worker's privacy is protected.

What is claimed is:

1. A node location method for a node location system including: nodes for sending location signals; a reference station for sending reference signals; a plurality of access points for receiving location signals and reference signals; a server for calculating the node position; and a network for connecting the access point and the server,
the node location method as in the reference station comprising the step of:
sending a reference signal in case that a location signal is received,
the node location method as in the access point comprising the steps of:
receiving the reference signal and the location signal;
detecting a specified pattern from the received reference signal and the location signal;
measuring the time from detecting the specified pattern from the location signal to detecting the specified pattern from the reference signal; and
sending the signal-receive-time information including the measured times to the server, and
the node location method as in the server comprising the steps of:
calculating the difference between the time the reference station received the location signal and the time that the access point received the location signal, based on the signal-receive-time information; and
calculating the node position based on the difference between the calculated times.

2. The node location method according to claim 1,
wherein the server calculates the difference between the time the reference station received the location signal and the time that the access point received the location signal, by subtracting:
a processing delay time required for the reference station to send the reference signal after receiving the location signal; and
a propagation delay time required for propagating the reference signal from the reference station to the access point,
from a time including a signal-receive-time information received from the reference station.

3. The node location method according to claim 2,
wherein the server calculates the propagation delay time by dividing the distance between the reference station and the access point by the speed of light.

4. The node location method according to claim 1,
wherein the server calculates the node position based on the difference in the calculated times, in case that the signal-receive-time information was received from two access points.

5. The node location method according to claim 1,
wherein the location signal and the reference signal are ultra wideband (UWB) signals.

6. The node location method according to claim 1,
wherein the specified pattern indicates the end of the preamble in at least one of the location signal and the reference signal.

7. A node positioning measuring system comprising:
nodes for sending location signals;
a reference station for sending reference signals;
a plurality of access points for receiving location signals and reference signals;
a server for calculating the node position; and
a network for connecting the access point and the server,
wherein the reference station includes:
a location signal receiver unit for receiving the location signals; and
a reference signal generator unit for sending the reference signal in case that the location signal receiver unit received the location signal,
wherein the access point includes:
a signal receiver unit for receiving reference signals and location signals;
a receive-time measurement unit for detecting a specified pattern from the reference signal and the location signal received by the signal receiver unit, and measuring the time from detecting the specified pattern from the location signal, to detecting the specified pattern from the reference signal; and
a communication unit for sending the signal-receive-time information including the time measured by the receive-time measurement unit to the server, and
wherein the server contains a position calculator unit for calculating the difference between the time the reference station received the location signal and the time the access point received the location signal, based on the signal-receive-time information received from the communication unit, and calculating the node position based on that calculated time difference.

8. The node positioning measuring system according to claim 7,
wherein the position calculator unit calculates the difference between the time the reference station received the location signal and the time the access point received the location signal, by subtracting:
a processing delay time required from the location signal receiver unit receiving the location signal to the reference signal generator unit sending the reference signal; and
a propagation delay time required for propagating the reference signal from the reference station to the access point,
from a time including the signal-receive-time information received from the communication unit.

9. The node positioning measuring system according to claim 8,
wherein the position calculator unit calculates the propagation delay time by dividing the distance between the reference station and the access point by the speed of light.

10. The node positioning measuring system according to claim 7,
wherein the position calculator unit calculates the node position based on the difference in the calculated times, in case that the signal-receive-time information was received from two communication units.

11. The node positioning measuring system according to claim 7,
wherein the location signal and the reference signal are ultra wideband (UWB) signals.

12. The node positioning measuring system according to claim 7,
wherein the specified pattern indicates the end of the preamble in at least one of the location signal and the reference signal.

13. A server connected by a network with multiple access points for receiving the reference signals that were sent in case that the node sent location signals and the reference station received the location signals,
wherein the server acquires from the applicable access point, the signal-receive-time information including the time the access point detected the specified pattern from the location signal, to the time the access point detected the specified pattern from the reference signal,
wherein the server calculates the difference between the time the reference station received the location signal and the time the access point received the location signal based on the acquired signal-receive-time information, and
wherein the server calculates the node position based on the difference between the calculated times.

14. The server according to claim 13,
wherein the server calculates the difference between the time the reference station received the location signal and the time the access station received the location signal, by subtracting:
a processing delay time required from the reference station receiving the location signal to sending the reference signal; and
a propagation delay time required for propagating the reference signal from the reference station to the access point,
from a time including the acquired signal-receive-time information.

15. The server according to claim 14,
wherein the server calculates the propagation delay time by dividing the distance between the reference station and the access point by the speed of light.

16. The server according to claim 13,
wherein the server calculates the node position based on the difference in the calculated times in case that the signal-receive-time information was acquired from two access points.

17. The server according to claim 13,
wherein the location signal and the reference signal are ultra wideband (UWB) signals.

18. The server according to claim 13,
wherein the specified pattern indicates the end of the preamble in at least one of the location signal and the reference signal.
